(19) United States
(12) Patent Application Publication
(10) Pub. No.: US 2025/0013509 A1
(43) Pub. Date: Jan. 9, 2025

(54) SYSTEM, METHOD AND COMPUTER-ACCESSIBLE MEDIUM FOR AN INTER-PROCESS COMMUNICATION TOOLS COUPLING SYSTEM

(71) Applicant: New York University in Abu Dhabi Corporation, Abu Dhabi (AE)

(72) Inventor: Benoit Joseph LUCIEN MARCHAND, Abu Dhabi (AE)

(73) Assignee: New York University in Abu Dhabi Corporation, Abu Dhabi (AE)

(21) Appl. No.: 18/887,264

(22) Filed: Sep. 17, 2024

Related U.S. Application Data
(63) Continuation of application No. PCT/IB2023/052635, filed on Mar. 17, 2023.
(60) Provisional application No. 63/320,806, filed on Mar. 17, 2022.

(51) Int. Cl. G06F 9/54

(52) U.S. Cl. CPC G06F 9/541

(57) ABSTRACT

Exemplary system, method and computer-accessible medium, according to exemplary embodiments of the present disclosure, can be used to couple, connect, associate, combine, link, or integrate inter-process communication tools (e.g., underlying inter-process communication (IPC) tools), and provide applications with a coupled IPC API (“application programming interface”), potentially different from that of the underlying IPC tools it relies upon. The exemplary procedures, system and/or methods can differentiate between the IPC API provided to an application by the present disclosure, and the IPC API(s) of the underlying tool(s) that is (are) being coupled to. The exemplary procedures, system and/or methods can integrate IPC tools when, e.g., the IPC API provided by the present disclosure is a sufficient subset of the underlying IPC API(s) to match an application's requirements, the application making use of the IPC interface is unaware that its IPC calls are being intercepted and redirected to one or more IPC tool(s).

### CROSS-REFERENCE TO RELATED APPLICATION(S)

This application relates to and claims priority from U.S. Patent Application No. 63/320,806, filed on Mar. 17, 2022, the entire disclosure of which is incorporated herein by reference.

### FIELD OF THE DISCLOSURE

The present disclosure relates generally to inter-process communication mechanisms, and more specifically, to exemplary embodiments of exemplary systems, methods and computer-accessible medium for inter-process communication mechanism coupling method(s)/procedure(s).

### BACKGROUND INFORMATION

In the field of computing, there may be a need to facilitate independent running processes to exchange information with one another, e.g., in the context of distributed computing. This can be defined as the field of inter-process communication (“IPC”) mechanisms. While some IPC tools are limited to intra-node communications, e.g., where all processes run on the same computer node, most IPC tools allow communicating parties to reside on different nodes, i.e., inter-node communication, and/or on the same node, i.e., intra-node communication. The most common IPC standard is Message Passing Interface (“MPI”) used widely throughput the industrial, governmental, academic, and scientific market sectors. The use of IPC tools can be the foundation of High Performance Computing (“HPC”), a $14B industry in 2021.

Many MPI implementations, such as OpenMPI, MPICH, MVAPICH2, and Intel MPI, work on a wide variety of platforms (processors and/or compute nodes) and interconnects, while other implementations may be, e.g., vendor, interconnect, or platform specific. And, while more generic implementations may support just about any platform, in some aspects, they may not be optimized for some of the interconnects, processors, node type, and operating system combination that a user may be considering using with an application. Even if an IPC tool implementation were to support every possible platform, it may be challenging to optimize all such combinations, e.g., either due to time constraints, cost, or technology. Finally, it may be currently challenging to run applications mixing MPI implementations simultaneously, for example, when one needs to run part of an application on a platform specific MPI implementation, and the rest of the application using a generic MPI implementation.

Thus, it may be beneficial to provide an exemplary system, method, and computer-accessible medium for inter-process communication mechanisms which can overcome at least some of the deficiencies described herein above.

### SUMMARY OF EXEMPLARY EMBODIMENTS

An exemplary system, method and computer-accessible medium, according to exemplary embodiments of the present disclosure, can alleviate these problems by facilitating the use of multiple independent IPC tools (e.g., underlying IPC tools) concurrently under the auspices of a single IPC tool framework (e.g., coupled IPC tool). An exemplary system, method and computer-accessible medium, according to exemplary embodiments of the present disclosure, can provide for IPC coupling transparently to the application's operation, and transparently to the IPC tools themselves. Thus, the exemplary system, method and computer-accessible medium can mix MPI implementations to enable platform specific computing components to interact with generic computing components, and/or to use selective portions of each IPC tool to optimize performance based on platform specific conditions.

An exemplary system, method and computer-accessible medium, according to exemplary embodiments of the present disclosure, can couple, connect, associate, combine, link, or integrate inter-process communication tools (herein referred to as “underlying IPC tools”), or IPC tools, and provide applications with a coupled IPC API (application programming interface), potentially different from that of the underlying IPC tools it relies upon.

An exemplary system, method and computer-accessible medium, according to exemplary embodiments of the present disclosure, can differentiate between the IPC API provided to an application by the present disclosure, and the IPC API(s) of the underlying tool(s) that is (arc) being coupled to.

An exemplary system, method and computer-accessible medium, according to exemplary embodiments of the present disclosure, can integrate IPC tools when, e.g., the IPC API provided by the present disclosure is a sufficient subset of the underlying IPC API(s) to match an application's requirements, the application making use of the IPC interface is unaware that its IPC calls are being intercepted and redirected to one or more IPC tool(s).

Regardless of the IPC API provided by the exemplary embodiments of the present disclosure, the underlying IPC tools themselves need not be modified, or made aware that they could be used jointly with other IPC tools.

Interception of IPC calls, in exemplary embodiments of the present disclosure, can refer to, but not limited to, any software means that facilitates a software tool to call other software tools. Examples of such tools can include, e.g., a library that an application is linked with during compilation or linking time, or a library that intercepts application calls at run time and then possibly proceeds to call other libraries (for example Linux LD_PRELOAD mechanism).

In exemplary system, method and computer-accessible medium, according to exemplary embodiments of the present disclosure, the IPC tools, when they implement a standard interface, such as, but not exclusively, MPI, need not implement the totality of the standard.

Other exemplary non-standard adhering IPC tools can implement a communication mechanism that will require the present disclosure to supplement their functionality in order to be coupled with other IPC tools.

An exemplary system, method and computer-accessible medium, according to exemplary embodiments of the present disclosure, can may not require that all IPC tools be of the same standard or type, and the IPC interface presented to user applications be of the same standard or type to that of the underlying IPC tools.

In exemplary system, method and computer-accessible medium, according to exemplary embodiments of the present disclosure, can be applied recursively, e.g., an IPC interface can be built using IPC tools which themselves are the result of the exemplary system, method and computer-accessible medium of the disclosure.

By presenting an IPC API of its own, the present disclosure can enable a single IPC API to be used by an application regardless of the IPC API(s) being actually used to transport data between processes. Hence, through the exemplary embodiments of the present disclosure one can develop applications that can operate with a variety of IPC tools transparently.

Exemplary system, method and computer-accessible medium, according to exemplary embodiments of the present disclosure, can facilitate exemplary real-time interactions with the operating system interconnect(s), and/or any other low-level mechanism, interfacing with the underlying IPC tool(s) in order to optimize performance and/or control the IPC tool(s) interactions.

In an exemplary system, method and computer-accessible medium, according to exemplary embodiments of the present disclosure, one or more of the following exemplary features can be present: (i) IPC calls made by the application can be intercepted and operated upon by the present disclosure, (ii) initialization of the IPC tools can be performed by the exemplary embodiments of the present disclosure on behalf of the application, (iii) process identification data structure, communicator identification data structure (if present), and communication request data structure (if present) as required by each IPC tool being used can be mapped, maintained, and substituted while performing IPC calls to the underlying IPC tools by the exemplary embodiments of the present disclosure, (iv) point-to-point IPC calls intercepted by the exemplary embodiments of the present disclosure can be redirected to the appropriate IPC tool based on conditions such as, but not limited to, process identification, interconnect type, processor type, operating system type, compute node type, application type, configuration file, historical database from prior runs, etc., (v) point-to-point IPC calls may require multiple calls to underlying IPC tools in order to connect a source process with a destination process through a forwarding method when there are, e.g., no direct path between two processes, (vi) asynchronous communication IPC calls from one IPC tool can be able to operate concurrently with those of other IPC tools by the exemplary embodiments of the present disclosure, (vii) collective IPC calls intercepted by the exemplary embodiments of the present disclosure can be redirected to the appropriate IPC tool based on specific conditions, e.g., similar to point-to-point IPC calls, (viii) potentially IPC calls can be handled recursively by the present disclosure such that one or more of the underlying IPC tool is itself the result of the present disclosure, (ix) multiple underlying IPC tools can be required to implement an IPC call by the exemplary embodiment of the present disclosure through a combination of point-to-point and/or collective, and/or forwarding IPC calls from a set of IPC tools, (x) IPC termination can be controlled by the present disclosure to terminate all IPC tools in operation in an orderly fashion, and (xi) the exemplary mechanism can interact with underlaying IPC tools, the operating system, and/or the interconnect hardware to optimize performance and resource usage and control the underlying IPC tools' operation.

Further, method, system and computer-accessible medium according to the exemplary embodiment of the present disclosure can be provided for facilitating inter-process communication (“IPC”) of a plurality of IPC processes or tools. For example, it is possible to, intercept at least one call from a first process or tool of the IPC processes or tools intended to be provided to a second process or tool of the IPC processes or tools using an IPC platform. At least one first IPC translation context of the IPC processes or tools can be identified based on the first process or tool. The first IPC translation context(s) can be translated to at least one second IPC translation context usable by the second process or tool.

For example, these procedures can be performed in a recursive manner and/or to preserve application compatibility through technological evolution of communication software tools and communication hardware interconnects. Additionally, it is possible to identify the first IPC translation context based on a destination IPC context. The first IPC translation context can be based on a process identifier, a node identifier, a node configuration, a network identifier, a network topology, user supplied preferences, and/or performance statistics.

According to additional exemplary embodiments of the present disclosure, the second process or tool can be unaware of the first process or tool. The first process or tool and/or the second process or tool can be invoked by at least one software application. Further, the software application(s) can be unaware that it interfaces with the first process or tool and/or the second process or tool. The first process or tool and the second process can be of a different type or the same type. The first process or tool can (a) implement less procedures than an entire IPC standard, (b) be configured to supplement a functionality of the second process or tool, (c) be configured to track, record, analyze, report, route, and/or optimize IPC calls on-the-fly, (d) be configured to substitute a functionality, in part or in totality, of the second process or tool with that of an optimized second process or tool based on runtime conditions.

In a yet additional exemplary embodiment of the present disclosure, the first process or tool can overlay, in part, a functionality of the second process or tool with that of a third process or tool in order to optimize or alter interactions between a software application and the second process or tools. In addition or alternatively, the first process or tool, by its ability to at least one of track, collect, or analyze IPC calls, can be configured to interact with:
a computer node operating system to change at least one of a priority, a process placement policy, an NUMA memory allocation or a migration of a running application process,
the second process or tool to set runtime parameters as a buffer allocation, a threshold between IPC component selection, or a channel selection,
a compute node resource including at least one of a processor, controllers, or accelerators to improve performance or stability,
a compute node processor to optimize at least one of a cache memory allocation or a bandwidth based on recorded information,
a network controller to provide the network controller with information on at least one of a current network traffic or an expected network traffic to optimize the runtime parameters as message routing or message priority, and/or
a communication pattern optimization mechanism that, based on at least one of a recent message tracking or a message analysis, at least one of reorders messages, aggregates messages, or substitutes application programming interface (“API”) calls.

For example, the communication pattern optimization mechanism can be based on a software module running within the first process or tool, an artificial intelligence (“AI”) module running on a GPU, or another software-based mechanism or hardware-based mechanism that, given a set of parametrized data, provides an optimized schedule of operation.

It is also possible to aggregate messages from the first process or tool and the second process or tool when the messages have a common route. Further, after completion or use of the first process or tool by a software application, the first process or tool can be available for use by another software application. The first process or tool can be configured to be used concurrently by multiple applications. It is possible to initialize the first process or tool and/or the first process or tool. It is further possible to terminate the first process or tool and/or the second process or toll when at least one of the IPC processes terminates.

According to yet additional exemplary embodiment of the present disclosure, the call(s) can be a point-to-point application programming interface (“API”) call when the first process or tool is not directly connected to the second process or tool. The point-to-point API call between the two processes can be achieved through a series of forwarding point-to-point calls between intermediate processes. The call(s) can be a collective API call when the first process or tool uses a combination of second processes or tools performing forwarding collective or the point-to-point API calls to reach all software application processes involved in the collective call. Additionally or alternatively, the call(S) can be a collective API call when the first process or tool uses a sequence of second processes or tools to optimize performance. The second process or tool can be optimized for an intra-node collective function, and thereafter, the second process or tool can be optimized for an inter-node collective function. It is further possible to perform an asynchronous communication operation by substituting blocking wait calls with non-blocking test calls.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1a is an exemplary block and flow diagram of a software stack common to most inter-process communication tools;

FIG. 1b is an exemplary block and flow diagram of a software stack according to an exemplary embodiment of the present disclosure;

FIG. 1c is an exemplary block and flow diagram of a software stack according to an exemplary embodiment of the present disclosure when at least one of the underlying IPC tools is itself an exemplary embodiment of the present disclosure (recursive use of the present disclosure);

FIG. 2 is an exemplary point-to-point IPC call flowchart diagram of an exemplary embodiment of the present disclosure;

FIG. 3a is an exemplary IPC context map according to an exemplary embodiment of the present disclosure;

FIG. 3b is an exemplary diagram of the overlap of IPC contexts resulting from FIG. 3a IPC context map;

FIG. 4 is an exemplary data structure map and operators according to an exemplary embodiment of the present disclosure;

FIG. 5a is an exemplary diagram of an exemplary IPC point-to-point forwarding mechanism according to an exemplary embodiment of the present disclosure;

FIG. 5b is an exemplary IPC point-to-point pseudo-code with explicit forwarding built-in to the application according to an exemplary embodiment of the present disclosure;

FIG. 5c is an exemplary IPC point-to-point pseudo-code using an asynchronous forwarding process according to an exemplary embodiment of the present disclosure;

FIG. 5d is an exemplary forwarding path search pseudocode according to an exemplary embodiment of the present disclosure;

FIG. 6 is an exemplary asynchronous communication progress and completion loop according to an exemplary embodiment of the present disclosure;

FIG. 7 is an exemplary recursive IPC collective mechanism according to an exemplary embodiment of the present disclosure;

FIG. 8a is an exemplary “gather” collective operation using a coupled IPC context built on top of a local shared memory IPC context and a global MPI IPC context;

FIG. 8b is an exemplary table providing the IPC contexts involved in FIG. 8a to implement a coupled IPC context implementing a gather collective operation;

FIG. 8c is an exemplary pseudocode to bridge the IPC contexts presented in FIG. 8b;

FIG. 8d is an exemplary diagram of the reverse translation rank reordering required after completion of the data exchange presented in FIG. 8c;

FIG. 9 is an exemplary graph of the memory bandwidth usage impact for an exemplary embodiment of the present disclosure;

FIG. 10 is an exemplary graph providing the scalability and speedup of an exemplary embodiment of the present disclosure; and

FIG. 11 is an illustration of an exemplary block diagram of an exemplary system in accordance with certain exemplary embodiments of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures and claims.

### DETAILED DESCRIPTION OF THE EXEMPLARY EMBODIMENTS

The exemplary system, method and computer-accessible medium, according to an exemplary embodiment of the present disclosure, can be used to couple, connect, associate, combine, link, and/or integrate IPC tools such that applications can benefit from the combined capabilities of more than one IPC mechanism, and/or such that applications can use an IPC tool application programming interface (API) while the potentially different underlying IPC tool(s) API(s) are being used.

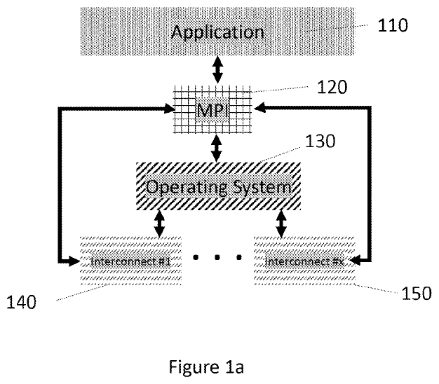

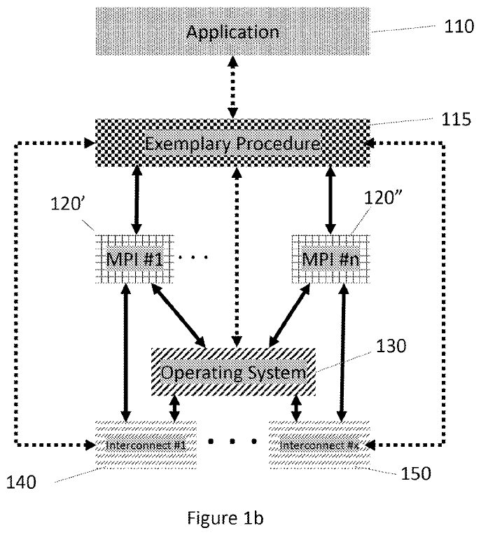

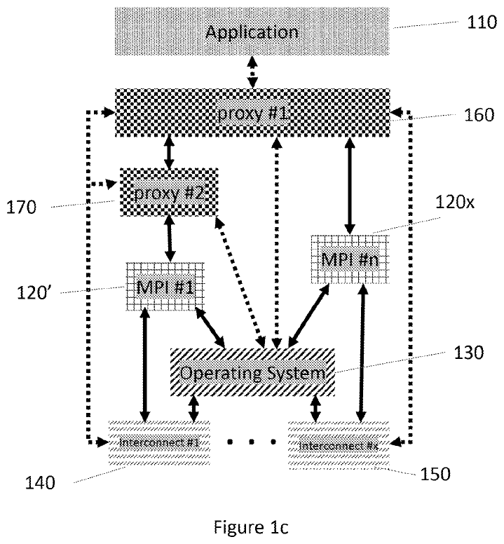

FIG. 1a illustrates an exemplary block and flow diagram of an exemplary application and MPI software stack. Such exemplary application 110 can interface with an MPI library tool through the MPI API 120 which in turn interfaces to the operating system 130a and/or directly interacts with the interconnect hardware in order to perform its function. An exemplary MPI tool can operate with more than one interconnect of, e.g., potentially different types, at a time (e.g., different interconnects 140a, 150a).

FIG. 1b shows an exemplary block and flow diagram of a software (MPI) stack according to an exemplary embodiment of the present disclosure. The dashed arrows show the new software interactions of the present disclosure which adds to the exemplary system shown in FIG. 1a. In one example, the exemplary systems, methods and computer-accessible medium according to exemplary embodiments of the present disclosure—via an exemplary procedure 115—can act as a proxy between an application and the underlying IPC tool(s). An exemplary application 110 can interact with the API according to the exemplary embodiments of the present disclosure. The exemplary systems, methods and computer-accessible medium according to exemplary embodiments of the present disclosure can then interact with underlying IPC tool(s), e.g., through multiple MPIs 120′, 120″, the operating system 130, and/or the interconnects 140, 150. The interactions between the exemplary systems, methods and computer-accessible medium according to exemplary embodiments of the present disclosure and the IPC tool(s) can remain as if they are an application interacting with an IPC tool, and most or all interactions between the IPC tool(s) and the operating system and/or the interconnect hardware can remain substantially identical to a normal operation.

FIG. 1b also illustrates that the exemplary systems, methods and computer-accessible medium according to exemplary embodiments of the present disclosure can facilitate interactions with the operating system 130 and/or interconnect hardware 140, 150 present, and/or any other system component in a compute node. The compute node can be, e.g., software or hardware. The exemplary embodiments of the present disclosure can optimize performance, and/or control IPC tool(s) interactions with such resources.

FIG. 1b further illustrates that the exemplary systems, methods and computer-accessible medium according to exemplary embodiments of the present disclosure can receive IPC API calls from applications. In an exemplary embodiment of the present disclosure, it is possible to track, record, analyze, report, route, and optimize IPC calls on-the-fly.

Moreover, exemplary systems, methods and computer-accessible medium according to exemplary embodiments of the exemplary embodiment of the present disclosure can, for example, also interact directly with the operating system and/or interconnect(s) to alter the priority message priority or routine.

As far as an application is concerned, the exemplary systems, methods and computer-accessible medium according to exemplary embodiments of the present disclosure can implement an IPC API with which it can interact. This API need not be identical to the underlying IPC tool(s). The exemplary embodiments of the present disclosure's API can implement a subset of the underlying IPC tool(s), or an altogether completely different API.

Moreover, if there are more than one underlying IPC tool being coupled, e.g., they need not all implement the same API protocol, either in part or in totality. For example, in an exemplary embodiment of the present disclosure the exemplary visible API (e.g., the calls that indicate an application available to an IPC tool) may not implement the MPI standard in totality; the application can run as per normal as long as the MPI calls it makes are supported by the visible API.

As a result, in an exemplary embodiment of the present disclosure, an application can be unaware that its IPC calls are being routed to other IPC mechanism(s) (e.g., application transparency). And the underlying IPC tools are unaware that they are being used by a proxy application (the exemplary embodiments of the present disclosure), or that other IPC tool(s) may be used concurrently (e.g., reverse transparency).

Moreover, the exemplary systems, methods and computer-accessible medium according to exemplary embodiments of the present disclosure allow for supplementing an underlying IPC's functionality. For example, in an exemplary embodiment of the present disclosure, the visible API can extend MPI's functionality by combining MPI calls, system calls, and/or other libraries' calls to perform a function not present in the MPI standard. Such extension could also be used to facilitate the coupling of different IPC APIs.

The exemplary systems, methods and computer-accessible medium according to exemplary embodiments of the present disclosure can also “translate” an IPC API into that of another IPC's API. For instance, in an exemplary embodiment of the present disclosure, the exemplary systems, methods and computer-accessible medium can facilitate an application to run with the PVM API (e.g., parallel virtual machine) while relying on an underlying MPI IPC tool, thus enabling an IPC “translation” mechanism from one API to another on-the-fly.

FIG. 1c shows an exemplary block and flow diagram of a software stack according to an exemplary embodiment of the present disclosure when at least one of the underlying IPC tools is itself an exemplary embodiment of the present disclosure (e.g., recursive use of systems, method and computer-accessible medium according to the exemplary embodiments of the present disclosure). Thus, FIG. 1c illustrates that the exemplary systems, methods and computer-accessible medium according to exemplary embodiments of the present disclosure can be applied recursively such that one or more of the underlying IPC tools can itself be the result of an IPC coupling. Such exemplary embodiment of FIG. 1c illustrates the use of proxies 160, 170 that interact with each other, as well as with the MPIs 120, 120x and/or interconnects 140, 150. This exemplary capability can result from the transparency and reversed transparency mentioned above. Such a capability could be used, for example, to cope with the rapid evolution of interconnects and IPC tools, enabling legacy tools to be used in a new IPC tool and/or interconnect technology context with minimal re-engineering.

The separation of IPC API and the actual underlying exemplary IPC tools used to transport data further can facilitate applications to benefit from immunity to new IPC tool developments and interconnect technologies by bridging the gap in the exemplary systems, methods and computer-accessible medium according to exemplary embodiments of the present disclosure rather than re-engineering applications.

An exemplary embodiment of the present disclosure can be implemented through developing an API library with which applications link during the build process, or alternatively, through an IPC API tool interception mechanism where the application can be linked with the underlying IPC API at build time, but where the IPC calls can be intercepted at run-time and processed by an exemplary embodiment. The latter method of interception can be built, in an exemplary embodiment of the present disclosure, using an LD_PRELOAD operating system loader mechanism found in all Linux operating systems.

The exemplary systems, methods and computer-accessible medium according to an exemplary embodiment of the present disclosure can be broken down into a series of exemplary discreet steps, features or procedures as described below. For example, not all the exemplary steps, procedures and/or features are required for all possible embodiments of the disclosure. The exemplary systems, methods and computer-accessible medium according to an exemplary embodiment of the present disclosure can be composed of the following exemplary procedures:
(i) interception of underlaying IPC tool(s) API calls
(ii) underlying IPC tool(s) initialization
(iii) underlying IPC tool(s) interface data structures
(iv) point-to-point operations underlying IPC tool(s) API processing
(v) point-to-point operations forwarding
(vi) underlying IPC tool(s) asynchronous API processing
(vii) collective operations underlying IPC tool(s) API processing
(viii) collective operations recursive use and forwarding
(ix) supplementing underlying IPC tool(s)
(x) underlying IPC tool(s) termination
(xi) performance tracking, analysis, and optimization

Below are further descriptions of the exemplary sub-procedures of an exemplary embodiment of the present disclosure.

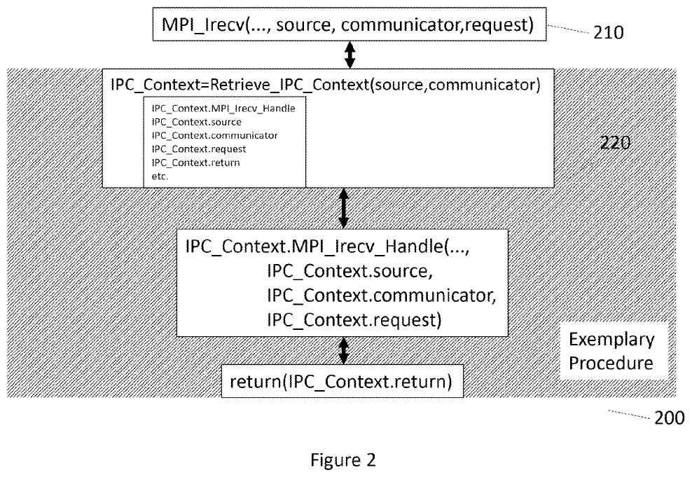

FIG. 2 illustrates a flow diagram of a method according to an exemplary embodiment of the present disclosure, where the IPC calls are intercepted by the exemplary systems, methods and computer-accessible medium according the embodiment of the present disclosure, processed, passed on to an underlaying IPC tool, and the return status of the IPC tool is passed back to the calling application. In this example, the exemplary systems, methods and computer-accessible medium can include and/or utilize a library pre-loaded using LD_PRELOAD—as described above—and where the embodiment of the procedure 200 can includes a function called “MPI_Irecv” 210. Thus, by calling MPI_Irecv function 210, the exemplary application actually calls the corresponding MPI_Irecv in the exemplary systems, methods and computer-accessible medium. The exemplary systems, methods and computer-accessible medium then can retrieve the IPC tool context corresponding to the circumstances. In this example, the selection of IPC tool context can depend—but is not limited to—the source MPI rank, and MPI communicator. Further, e.g., the resulting IPC_Context 220 can be an exemplary complex structure containing a pointer to the underlying IPC tool's MPI Irecv function, the source, communicator, and request to use in that context, and the returning status type. The exemplary systems, methods and computer-accessible medium can maintain one such exemplary complex structure for each coupled underlying IPC tool.

The initialization process of the exemplary systems, methods and computer-accessible medium according exemplary embodiments of the present disclosure can vary from one embodiment to another. In one exemplary embodiment, all or some of the coupled underlying IPC tools can be initialized upon startup, while in another exemplary embodiment, they could be initialized on-demand wherever a new IPC tool is needed to complete an API request. The determination of which IPC tool should be coupled can further be done by various means. In an exemplary embodiment of the present disclosure a list of process identifiers (IDs) with corresponding IPC tool identifiers can be parsed, and in another exemplary embodiment, the IPC tool connection can be made at run-time by the embodiment scanning for a matching initialization IPC call (for example MPI_Init) in the libraries found in its LD_LIBRARY_PATH environment variable (Linux).

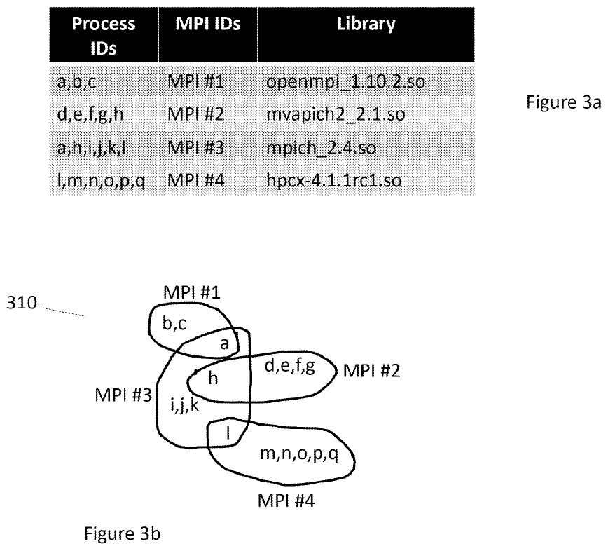

The list of underlying exemplary IPC tool(s) can be further provided through various ways. In one exemplary embodiment of the present disclosure, the list of IPC tools can be provided through a configuration file. FIG. 3a illustrates such an exemplary embodiment of the present disclosure for an exemplary IPC Context Map, where the list of process IDs and MPI libraries to use for each process ID is provided in a configuration file. In one example, processes “a”, “b”, and “c” use the same openmpi_1.10.2.so MPI implementation, and that “a” is also part of a group of processes that can communicate with one another using mpich_2.4.so MPI implementation. In one example, a process using more than one MPI implementation at a time may be only possible using the exemplary embodiments of the present disclosure.

FIG. 3b shows an exemplary IPC Context diagram 310 with a table illustrating the relationship between underlying IPC tools and process identifiers depicted in FIG. 3a. As can provided in FIG. 3b, each of exemplary processes “a”, “h”, and “l” interacts with the other processes through more than one MPI tool. This can be a departure from the MPI standard, and beneficial in accordance with the exemplary embodiments of the present disclosure. Nonetheless, a process according to the exemplary embodiments of the present disclosure can interact with more than one underlying IPC tool API. Thus, the methods, systems and computer-accessible medium according to the exemplary embodiments of the present disclosure can facilitate exemplary applications to interconnect with systems built upon dissimilar proprietary, standards, methods, etc. IPC tools.

In another exemplary embodiment of the present disclosure, the list of underlying IPC tool(s) can be generated at run-time by the exemplary embodiments of the present disclosure by scanning the library path of the running application (for example the Linux LD_LIBRARY_PATH environment variable), or by retrieving the list of libraries used to build the application (for example Linux objdump command), or by simply using a user-provided environment variable containing the list of underlying IPC tool(s), or by any other similar run-time means made available through the operating system.

Exemplary process identification can vary in a significant manner from one exemplary embodiment to another. In an exemplary embodiment of the present disclosure, it is possible to use the OMPI_COMM_WORLD_RANK environment variable, e.g., if an application is launched through “mpirun” (openmpi variable set by mpirun/mpiexec at launch time). In another exemplary embodiment, where a distributed application is launched through “ssh” calls, a user can supply identifiers on his own, using a user-supplied environment variable for example. Moreover, other exemplary embodiments of the present disclosure can be based on a discovery process where no process identifier is provided at startup and where exemplary systems, methods and computer-accessible medium according to an exemplary embodiment implements a discovery method to find processes involved in a distributed application at run-time.

In order to couple multiple IPC tools, or to substitute an IPC tool's API to another one, exemplary systems, methods and computer-accessible medium according to an exemplary embodiment of the present disclosure can utilize data structures to translate certain functionalities or information from underlying IPC tool(s) to the embodiment's own API requirements.

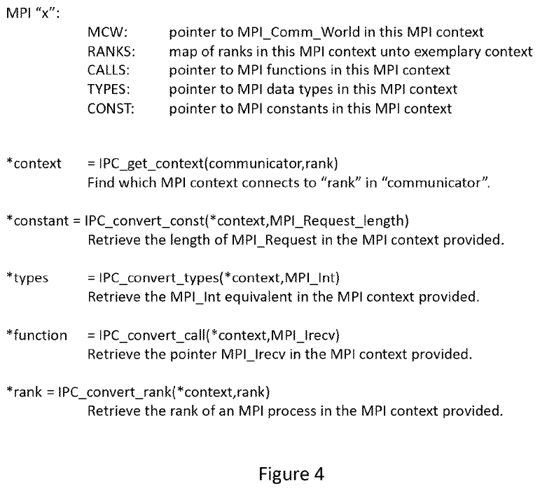

FIG. 4 illustrates an exemplary data structure translation mechanism (with exemplary IPC data structure maps and functions) for the use with the exemplary systems, methods and computer-accessible medium according to an exemplary embodiment of the present disclosure. In this example, there can be 5 (or more or less) different types of information that can support a translation in this exemplary embodiment, i.e., an exemplary mechanism to translate from the base MPI communicator (MPI_COMM_WORLD) of an underlying MPI tool to the MPI communicator presented to applications by the embodiment, a mechanism to translate an underlying MPI tool rank to that of the embodiment's own list of MPI ranks, a mechanism to translate an underlying MPI tool constants to equivalents in exemplary systems, methods and computer-accessible medium according to an exemplary embodiment of the present disclosure, an exemplary mechanism to translate an underlying MPI tool data types structures to equivalents in the embodiment, and a mechanism to translate underlying MPI tool API calls to equivalents in exemplary systems, methods and computer-accessible medium according to an exemplary embodiment of the present disclosure. This is only an example, and that other embodiments may require or implement a further translation support between underlying IPC tools and the coupled embodiment visible to applications. The exemplary systems, methods and computer-accessible medium according to various exemplary embodiments of the present disclosure refers to a set of data structure translation mechanisms for an underlying IPC tool as an “IPC context” or “IPC translation context”.

In exemplary embodiments of the present disclosure, the IPC context need not implement or utilize all translations. For example, as shown in FIG. 4, the set of IPC data structure translations can be or include a subset of all data structures supported by an underlying IPC tool. Similarly, not all constants or API calls in the example described herein above need have a translation equivalent. For example, the process identifier translation can be, e.g., partial as illustrated in FIGS. 3a and 3b. Not all processes may interact with all underlying MPI tools. The extent of support for data structure translation in an IPC context may depend on application requirements, coupling design objectives, or any other constraint or requirement.

In an exemplary embodiment of the present disclosure, an IPC context need not be global. For example, the IPC context may not be visible to all processes involved. For example, an IPC context, in an exemplary embodiment of the present disclosure, can span a single node, and each node may have its own local IPC context.

Moreover, an IPC context life cycle need not be limited to that of, e.g., the run-time of an application. For example, it may be present prior to an application starting execution, and/or it can persist after an application terminates.

An exemplary embodiment of the systems, methods and computer-accessible medium according to the present disclosure can launch applications itself/themselves, e.g., without the use of an external launcher mechanism, such as “ssh” or other mechanism commonly used with MPI and other IPC tools.

An IPC context needs not be reserved for a single application. For instance, in an exemplary embodiment of the present disclosure an IPC context that persists after an application terminates can be reused for a following application, and/or it can serve multiple applications concurrently. Thus, in an exemplary embodiment of the present disclosure, an IPC context can support the MPMD programming paradigm (Multiple Program Multiple Data) where the various independent programs taking part in the MPMD model can join or leave at any time (not necessarily started and terminated simultaneously).

FIG. 4 further illustrates an exemplary mechanism to retrieve the most appropriate IPC translation context given a destination process identifier and an MPI communicator. In this exemplary embodiment of the present disclosure, once an application makes an IPC call, the coupled exemplary mechanism can intercept the call and using “IPC_get_context” retrieves the IPC context needed to execute the API call using underlying IPC tools. In this particular example, there may not be any need to maintain a process translation mechanism for all MPI communicators used by the application. In one example, the coupled exemplary mechanism can first translate a process identifier (e.g., MPI rank) from a communicator to the MPI_COMM_WORLD base communicator using existing API calls from the underlying MPI tools. Then using the rank from the MPI_COMM_WORLD it can retrieve the IPC context that connects the present process to the remote (rank provided as a parameter) process.

Using the exemplary illustrations shown in FIGS. 3a and 4, the following MPI_Recv API call can be illustrated. For example, if process “d” wants to perform an MPI_Recv operation with process “f”. In such exemplary situation, process “d” can call IPC_get_context (MPI_COMM_WORLD, “f”) which can return to process “d” the IPC context associated with the underlying MPI tool, in this case: “MPI #2”.

In one example, the selection of an IPC context can be based on a variety of conditions, such as, but not limited to, process identifier, node identifier, node configuration, network identifier, network topology, user supplied preferences, performance matrix, etc.

Moreover, in a further example, more than one underlying IPC context can be used or needed to implement a set of IPC primitives as required by an application. For instance, in an exemplary embodiment of the present disclosure, an underlying IPC context can provide an optimized version of a few MPI primitives, such as MPI_Irecv and MPI_Isend, while another underlying IPC context provides support for the remaining MPI primitives required needed to run an application. In this exemplary case, the exemplary embodiment can give a higher priority to the optimized IPC context when encountering an MPI_Irecv call. In one example, this possibility to overlay IPC contexts in the exemplary embodiments of the present disclosure can be beneficial to use the present IPC coupling method to improve IPC tools performance by substituting optimized IPC primitives to those of the original IPC tool. In addition, overlaying IPC contexts facilitates a run-time determination of which underlying IPC tool to use transparently to the application. In an exemplary worst-case scenario, an application can always use the uncoupled IPC tool context, thus reducing or eliminating a risk of production interference due to the use of a coupled IPC tool.

In an exemplary embodiment of the present disclosure, when a point-to-point API call is made (e.g., one process communicating with another process) by an application, the exemplary systems, methods and computer-accessible medium according to an exemplary embodiment of the present disclosure, e.g., can capture the call, retrieve the IPC context, proceed to the necessary translations, invoke the appropriate underlying IPC tool's API to perform the operation on its behalf, and return the execution status from the underlying IPC API back to the application. This exemplary process can further include, e.g., tracking, recording, analyzing, and optimizing. Moreover, the exemplary process can, e.g., encompass more involvement from the coupled exemplary mechanism according to the exemplary embodiment of the present disclosure.

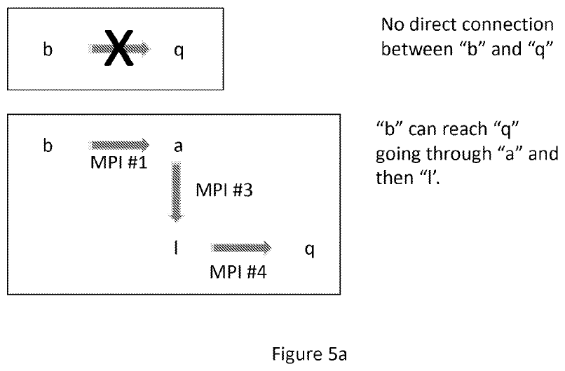

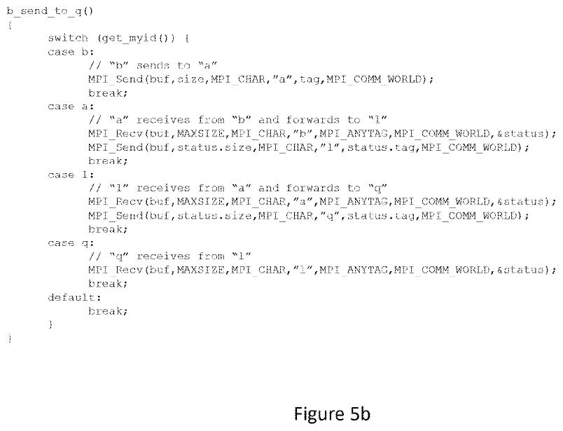

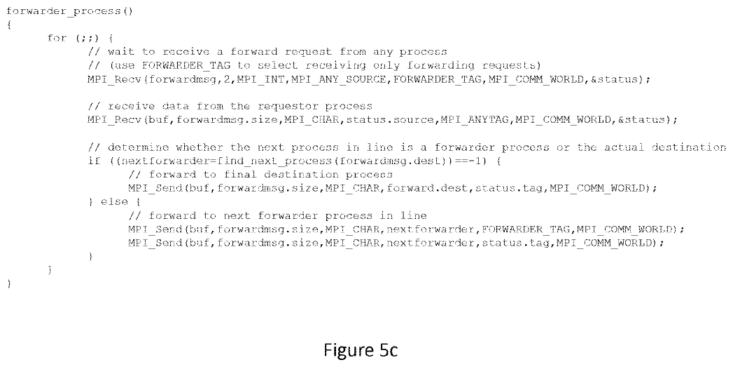

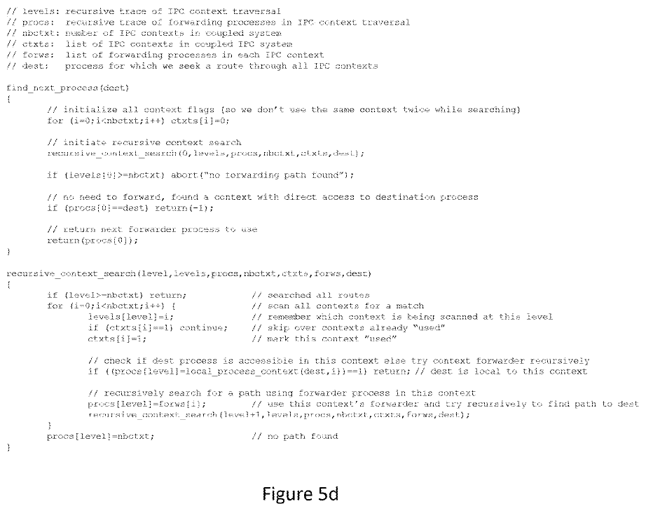

One such exemplary case where exemplary systems, methods and computer-accessible medium according to an exemplary embodiment of the present disclosure can proceed to perform more complex tasks is when no IPC context connects directly two communication processes; then exemplary systems, methods and computer-accessible medium according to an exemplary embodiment of the present disclosure can perform a series of forwarding point-to-point API calls through a series of IPC context in order to complete a point-to-point operation between processes belonging to different IPC contexts. FIG. 5a illustrates an exemplary diagram of an exemplary IPC point-to-point forwarding mechanism according to an exemplary embodiment of the present disclosure.

An exemplary point-to-point forwarding mechanism can be implemented in several ways. In one exemplary embodiment, it is possible for each mid-point process to explicitly make IPC API calls as shown in FIG. 5b which provides an exemplary IPC point-to-point explicit forwarding pseudo-code. In another exemplary embodiment, it is possible that the coupled embodiment can maintain a forwarding process for each underlying IPC tool whose purpose is to receive and execute forwarding requests between IPC contexts as in FIG. 5c which provides an exemplary IPC point-to-point asynchronous forwarding pseudo-code. The forwarding mechanism itself can, for example, in an exemplary embodiment, implement an IPC context patch search to the sequence of IPC contexts that must be traversed from a process to exchange data with another process. FIG. 5d illustrates an exemplary forwarding path search pseudo-code, according to an exemplary embodiment of the present disclosure, with which, given a destination process and a list of IPC context structures (such as shown in FIGS. 3a and 4), a search can be conducted, e.g., using a recursive backtracking algorithm/procedure. These are not an exhaustive list of forwarding mechanisms that the exemplary embodiments of the present disclosure can implement. The exemplary embodiments of the present disclosure's use of IPC contexts may not impose limits or restrictions on point-to-point forwarding mechanisms as it is built upon existing underlying IPC tools point-to-point communication mechanisms.

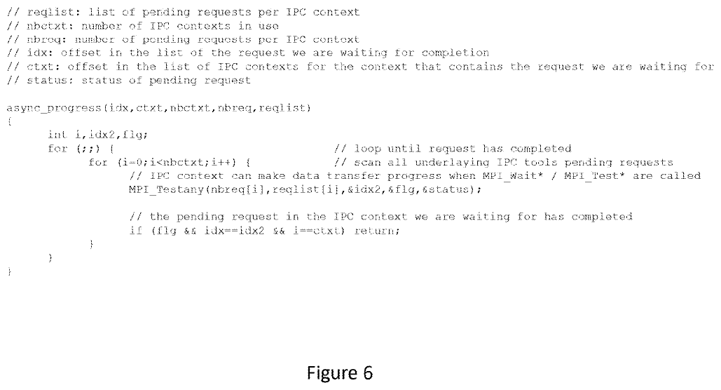

Another exemplary case, e.g., where an exemplary embodiment of the present disclosure can proceed to perform more complex tasks, can be when performing asynchronous communication operations (whether point-to-point or collective operations). Many IPC tools wait until a completion test or wait call is perform before actually performing asynchronous operations. According to an exemplary case, coupling multiple IPC tools asynchronous operations performance would suffer if a blocking wait call is translated into an IPC tool's corresponding blocking wait call through an IPC context. Thus, exemplary systems, methods and computer-accessible medium according to an exemplary embodiment of the present disclosure can prevent performance degradation and support multiplexing of asynchronous operations emanating from multiple underlying IPC tools simultaneously during IPC calls to wait upon the completion of asynchronous operations by substituting blocking wait calls with non-blocking test calls. FIG. 6 illustrates a pseudocode for such exemplary embodiment of an MPI_Wait( ) IPC API call which uses an exemplary asynchronous progress completion loop. As can be seen in FIG. 6, e.g., the progress can be implemented and/or assured amongst all IPC contexts, where asynchronous operations are active, by scanning for completion of asynchronous operations across all active IPC contexts. In this exemplary embodiment, this can be achieved by maintaining a list of all active asynchronous operations for each context and testing for the completion of any operation. In such exemplary manner, communication progress can be maintained instead of blocking the call process and stopping progress for all IPC contexts.

In an exemplary embodiment of the present disclosure, when a collective API call is made by an application (one process communicating with many, or many communicating with one, or many communicating with many), exemplary systems, methods and computer-accessible medium according to the embodiment of the present disclosure can, e.g., capture the call, retrieve the IPC context, proceed to the necessary translations, invoke the appropriate underlying IPC tool's API to perform the operation on its behalf, and return the execution status from the underlying IPC API back to the application. This exemplary process can further include, e.g., tracking, recording, analyzing, and optimizing. Moreover, the exemplary process can encompass, e.g., more involvement from the coupled exemplary mechanism.

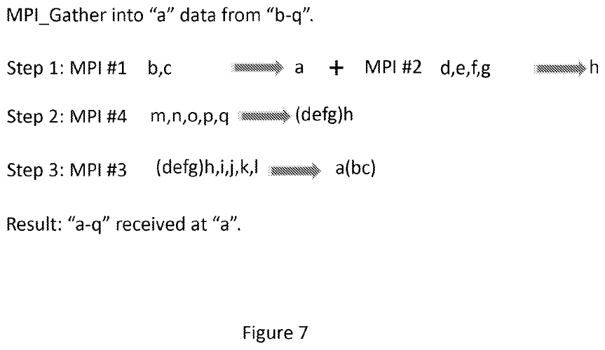

As in the case of point-to-point API calls, exemplary systems, methods and computer-accessible medium according to an exemplary embodiment of the present disclosure can implement a forwarding mechanism to support collective API calls across multiple IPC contexts. Forwarding across IPC contexts can be the result of adding point-to-point calls to bridge two IPC contexts, or it can be the result of identifying “bridging” processes in each IPC context which, one top of participating in collective calls as per usual, will perform additional collective calls to propagate collective calls across IPC contexts, or it can be the result of a combination of collective and point-to-point “bridging”. FIG. 7 illustrates such exemplary collective forwarding mechanism (which includes an exemplary IPC collective call recursive processing procedure), using the exemplary IPC context map shown in FIG. 3a. In this exemplary process, as shown in FIG. 7, “a” can gather data from processes “b” through “q”. In a first exemplary procedure (e.g., procedure/step #1), IPC context “MPI #1” performs a local gather for “b” and “c” into process “a”, while IPC context “MPI #2” performs a local gather for processes “d” through “g” into process “h”. At the completion of procedure/step #1, process “a” has gathered data from “a,b,c”, while process “h” has data from “d,e,f,g”. In procedure/step #2, IPC context “MPI #4” performs a local gather for processes “m” through “q” into process “h”. At the end of this exemplary procedure/process #2, “a” has data from “a,b,c”, and “h” has data from “d,e,f,g,h,m,n,o,p,q”. Further, in procedure/step #3, process “a” performs a collective call using IPC context “MPI #3” with processes “h,i,j,k,l”. At the end of step #3, process “a” has collected data from processes “a” through “q” thus completing a collective “gather” call across all processes.

The exemplary bridging process for collective operations described herein can itself utilize an already coupled IPC context. The exemplary embodiments of the present disclosure can be or include a recursive process where one or more of the underlying IPC tools can itself be a coupled exemplary embodiment of the present disclosure.

The exemplary systems, methods and computer-accessible medium according to exemplary embodiment according to the present disclosure can be used to supplement an underlying IPC tool with additional functionality to facilitate coupling IPC contexts and bridging across them. For example, there may be a desire to couple a Linux shared memory IPC tool (ex:/dev/shm file that is mmap'ed into an application's memory) with an MPI IPC tool library. Since memory mapped files may have no MPI_Recv in the shared memory API an exemplary embodiment of a coupling between these two IPC tools can supplement shared memory API with an MPI_Recv function (using shared memory operations). This, e.g., supplemental MPI_Recv function can then be used for bridging, forwarding, or coupling both IPC contexts.

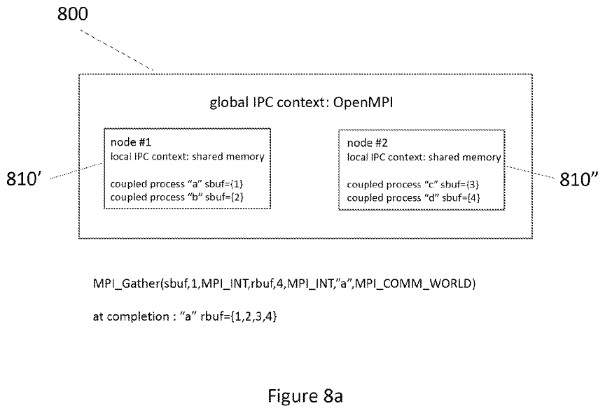

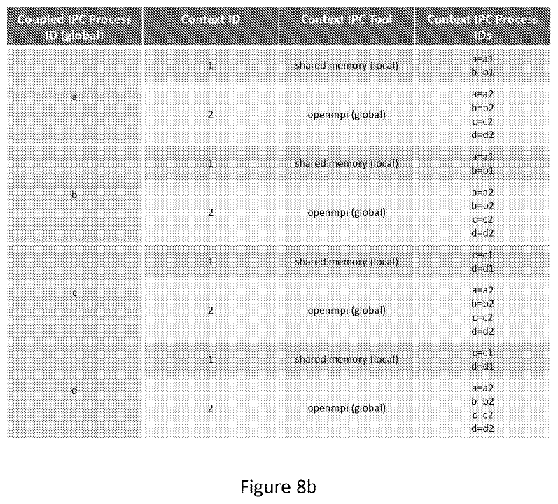

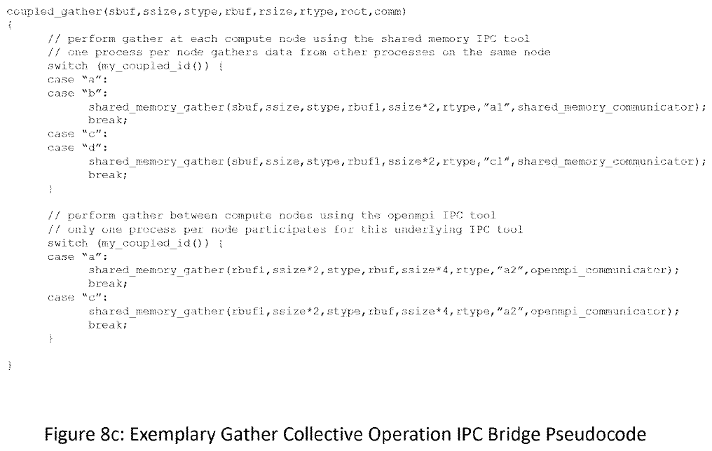

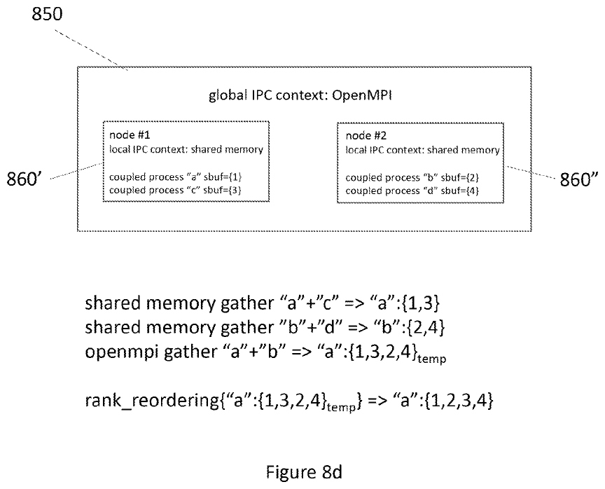

FIG. 8a illustrates a diagram of an exemplary embodiment of the present disclosure for the MPI gather collective operation 800. For example, it is possible to gather using Linux shared memory and an MPI library, where the shared memory represents an underlying IPC context 810′, 810″ local to each compute node and the MPI library is an underlying IPC context used to communication between compute nodes. In this example, the shared memory IPC context can be local to each node; each compute node can implement its own—potentially different—version of this underlying IPC tool. FIG. 8b illustrates an exemplary IPC context rank mapping (using exemplary gather collective operation IPC contexts), where the exemplary IPC coupling maintains tables to translate a global process identifier into that of the identifier for each underlying IPC tool. FIG. 8c shows an exemplary underlying IPC coupling pseudo-code to perform the MPI_Gather collective operation. As can be seen in FIG. 8c, the coupling can include a two-step gather operation, one gather for each compute node where, e.g., one process per node receives data from the other processes with which it shares the node, and the second gather is performed between the receiving processes in the previous step. FIG. 8d shows an exemplary IPC context rank mapping diagram 850, in which the coupled process identifiers are mapped to different nodes 860′, 860″ than those shown in FIG. 8b. In this exemplary case, e.g., for the coupled gather operation to perform correctly, the systems, methods and computer-accessible medium according to an exemplary embodiment of the present disclosure can shuffle the results in the correct order using a reverse process identifier translation operation (e.g., rank reordering).

The termination of a coupled exemplary mechanism according to an exemplary embodiment of the present disclosure can be performed in a variety of ways, such as, but not exclusively, when an application explicitly calls an IPC exit function, when the application terminates—for example using Linux “atexit” function, or may even never be terminated at all—e.g., leaving the coupled embodiment waiting for the next application to use it. Moreover, the exemplary termination process itself can include, but not exclusively, calling a termination function for each underlying IPC tool, or only a subject of them, leaving the others in stand-by operating mode.

An exemplary underlying IPC tool, or the coupled exemplary mechanism according to the exemplary embodiments of the present disclosure may be operating at most or all times—not limited by the duration of an application—such that the same coupled exemplary mechanism can be used by a more than one application consecutively, or even concurrently. A coupled exemplary mechanism can be used by more than one application at the same time. In one example, a coupled exemplary embodiment can be part of a daemon (service provider process running continually) or be integrated into a network interface card, or any other co-processor device.

The exemplary systems, methods and computer-accessible medium according to an exemplary embodiment of the present disclosure can perform more tasks than provide an IPC API. For example, using through the interception and processing of the IPC calls it can build up knowledge about an application and perform functions to improve performance, and/or alter the application's operation, through the operating system, underlying IPC tools, network interface hardware, and/or any other software/hardware device present in an operating environment. This non-exhaustive exemplary list illustrates some of the additional tasks that exemplary systems, methods and computer-accessible medium according to an exemplary embodiment of the exemplary embodiments of the present disclosure, which can perform, e.g.:
(a) recording of API calls and timings for immediate use in optimizing performance, post-processing, reporting, and planning future executions of the application;
(b) interacting with the operating system to alter process scheduling priorities, processor, core placement policy, NUMA memory allocation, migration, etc.;
(c) interacting with the underlying IPC tools to change operating parameters such a buffer allocation, thresholds between MPI component selection, channel selection, etc.
(d) interacting with the compute node processor board, controllers, accelerators, and/or processors, etc. to improve performance and/or system stability;
(e) controlling L3 cache allocation across cores at run-time so that not every processor core can use the whole of the L3 cache. Such exemplary mechanism can benefit application suffering from false sharing for instance;
(f) controlling L3 to memory bandwidth allocation on a core basis such as to ensure more balanced performance;
(g) interacting with a network controller, for example, to provide information on message passing activity that can be used by a controller to reorder packets to improve performance;
(h) controlling parameters in a network controller to allow some message higher priority over others (something that the MPI standard doesn't support), or control packet routing based on statistical analysis;
(i) recognizing communication patterns from one application iteration to another and, possibly using an AI (Artificial Intelligence) module—using, e.g., a GPU, accelerator built-in to a multicore processor, or a network controller's FPGA or processor—to determine a pattern which can be optimized and substituted at run-time by a more efficient one without the application being aware; and
(j) recognizing that several processes using the same network controller communicate with the same nodes, and group, and ungroup, messages together, possibly compressing them too, such as to minimize the number of independent message exchanges, and their sizes, between nodes at run-time.

For example, it is possible to use a communication path optimization in accordance with the exemplary embodiments of the present disclosure, which can include reducing or minimizing the memory bandwidth and/or interconnect bandwidth needed to exchange data between communicating processes. The path optimization can be applied for the data transfer itself and/or for the synchronization used to perform a data exchange.

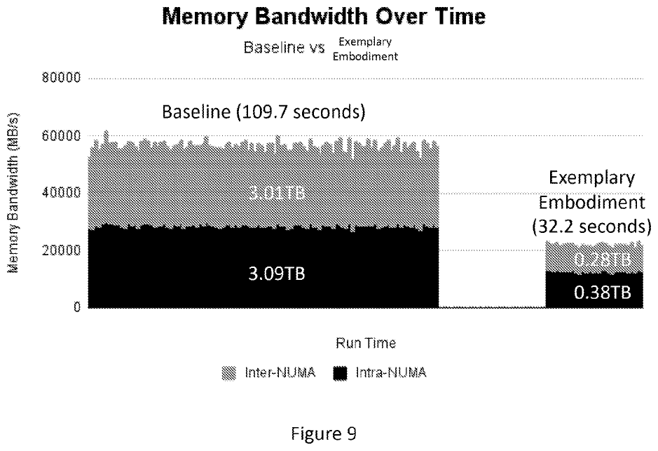

FIG. 9 illustrates an exemplary graph of the exemplary performance impact for a memory bandwidth usage of exemplary systems, methods and computer-accessible medium according to an exemplary embodiment of the present disclosure on a 2D Halo Ping-Pong test running on a 128 cores compute node (2× AMD 7742-8 NUMA nodes with 16 cores each). For example, a 2D Halo Ping-Pong test simulates the data transfers between processes on most distributed application; each process exchanges data with its 4 nearest neighbors. In this example, the “baseline” uses HPC-X 4.1.1rcl MPI from Mellanox, and the “disclosure” uses a coupled IPC mechanism using a minimal implementation of the MPI protocol based on shared memory overlaying HPC-X MPI.

Moreover, the exemplary systems, methods and computer-accessible medium according to the present disclosure, e.g., a coupled IPC context makes use of process placement optimization, process pinning to specific processor cores, and NUMA memory allocation and migration. The X-axis represents the run-time of each test; the Y-axis represents the memory bandwidth (both intra-NUMA and inter-NUMA memory bandwidth) measured at each second throughout execution. In FIG. 9, the “baseline” test ran in 109.7 seconds and required 6.1 TB of memory transferred, while the “disclosure” test—using the same application binary—ran in 32.2 seconds and required 0.66 TB of memory to be moved. This test demonstrates that the exemplary embodiments of the present disclosure facilitate substantial performance gains to be obtained with no application or underlaying MPI modifications. Moreover, the effort required to develop the coupled IPC method and to implement the minimalist underlying shared memory IPC tool was less than 2 man-months of coding—HPC-X MPI, by comparison, is estimated to be several thousand man-years of coding effort.

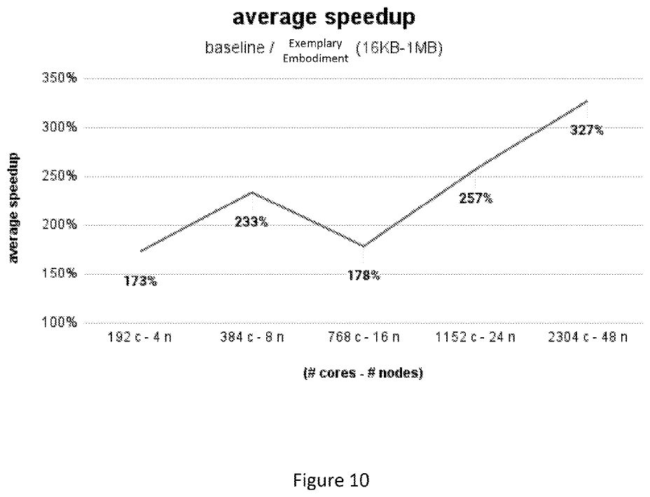

FIG. 10 shows an exemplary graph of the exemplary speedup and scalability of the same IPC context that the exemplary systems, methods and computer-accessible medium according to exemplary embodiment of the present disclosure as used with the information provided in FIG. 9. In this exemplary case, Intel Cascade Lake processors (48 processor cores per compute node) was used. The test was scaled from 1 node to 48 nodes. The performance gains for messages ranging from 16 KB until 1 MB was averaged, and speedup (baseline time/disclosure time) was calculated. In this test, the minimalist MPI context was used for intra-node data transport, and the HPC-X MPI context was used for the inter-node data transport. The selection of IPC context to use was determined by the coupled IPC context embodiment and was transparent to the application and both underlying IPC contexts. As can be seen, the coupled IPC exemplary mechanism is more scalable than the HPC-X MPI tool.

FIGS. 9 and 10 provide exemplary illustrations of the reduction of manpower used to optimize MPI implementations, and, simultaneously, the potential for application performance increase. Rather than starting from scratch developing a new MPI implantation (or a new communication layer) one can simply use the best components of various MPI implementations and couple them into a new MPI context.

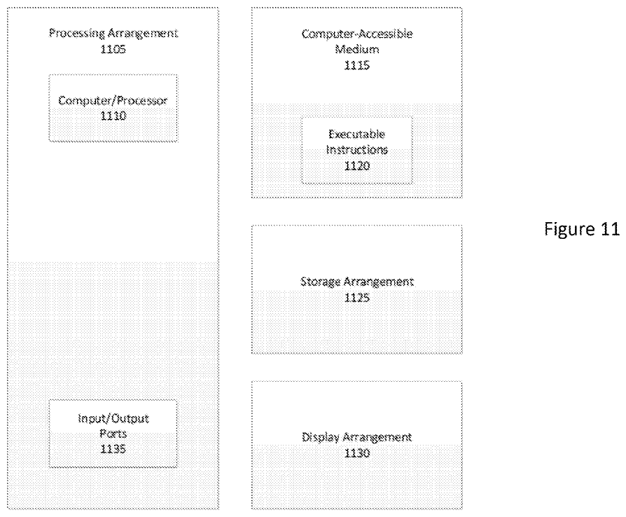

FIG. 11 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 1105. Such processing/computing arrangement 1105 can be, for example entirely or a part of, or include, but not limited to, a computer/processor 1110 that can include, for example one or more microprocessors, and use instructions stored on a computer-accessible medium (e.g., RAM, ROM, hard drive, or other storage device).

As shown in FIG. 11, for example a computer-accessible medium 1115 (e.g., as described herein above, a storage device such as a hard disk, floppy disk, memory stick, CD-ROM, RAM, ROM, etc., or a collection thereof) can be provided (e.g., in communication with the processing arrangement 1105). The computer-accessible medium 1115 can contain executable instructions 1120 thereon. In addition or alternatively, a storage arrangement 1125 can be provided separately from the computer-accessible medium 1115, which can provide the instructions to the processing arrangement 1105 so as to configure the processing arrangement to execute certain exemplary procedures, processes, and methods, as described herein above, for example.

Further, the exemplary processing arrangement 1105 can be provided with or include an input/output ports 1135, which can include, for example a wired network, a wireless network, the internet, an intranet, a data collection probe, a sensor, etc. As shown in FIG. 11, the exemplary processing arrangement 1105 can be in communication with an exemplary display arrangement 1130, which, according to certain exemplary embodiments of the present disclosure, can be a touch-screen configured for inputting information to the processing arrangement in addition to outputting information from the processing arrangement, for example. Further, the exemplary display arrangement 1130 and/or a storage arrangement 1125 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference, in their entireties:
1) https://www.open-mpi.org/
2) https://www.mpich.org/
3) https://mvapich.cse.ohio-state.edu/
4) https://developer.nvidia.com/networking/hpc-x
5) https://www.hpe.com/psnow/doc/a00074669en_us
6) https://www.mcs.anl.gov/research/projects/mpi/standard.html
7) https://www.csm.ornl.gov/pvm/
8) https://en.wikipedia.org/wiki/Distributed_object_communication
9) https://en.wikipedia.org/wiki/Remote_procedure_call
10) https://en.wikipedia.org/wiki/Memory-mapped_file
11) https://en.wikipedia.org/wiki/Message_Passing_Interface
12) https://juliapackages.com/p/mpi
13) https://www.mathworks.com/help/parallel-computing/mpilibconf.html
14) https://opam.ocaml.org/packages/mpi/
15) https://pari.math.u-bordeaux.fr/dochtml/html/Parallel_programming.html
16) https://hpc.llnl.gov/sites/default/files/pyMPI.pdf
17) https://cran.r-project.org/web/packages/Rmpi/Rmpi.pdf

1. A method for facilitating inter-process communication (“IPC”) of a plurality of IPC processes or tools, comprising:
a) using an IPC platform, intercepting at least one call from a first process or tool of the IPC processes or tools intended to be provided to a second process or tool of the IPC processes or tools;
b) identifying at least one first IPC translation context of the IPC processes or tools based on the first process or tool; and
c) translating the at least one first IPC translation context to at least one second IPC translation context usable by the second process or tool.

2. The method of claim 1, further comprising performing the procedures (a)-(c) in a recursive manner.

3. The method of claim 2, further comprising terminating at least one of the first process or tool or the second process or toll when at least one of the IPC processes terminates.

4. The method of claim 1, further comprising performing procedures (a)-(c) to preserve application compatibility through technological evolution of communication software tools and communication hardware interconnects.

5. The method of claim 1, wherein the second process or tool is unaware of the first process or tool.

6. The method of claim 1, wherein:
at least one of (i) the first process or tool or (ii) the second process or tool are invoked by at least one software application, and
the at least one software application is unaware that the at least one software application interfaces with the at least one of the first process or tool and the second process or tool.

7. The method of claim 1, wherein the first process or tool and the second process are of a different type.

8. The method of claim 1, wherein the first process or tool and the second process are the same type.

9. The method of claim 1, wherein the first process or tool implements less procedures than an entire IPC standard.

10. The method of claim 1, wherein the first process or tool is configured to at least one of (i) supplement a functionality of the second process or tool, (ii) track, record, analyze, report, route, or optimize IPC calls on-the-fly, or (iii) substitute a functionality, in part or in totality, of the second process or tool with that of an optimized second process or tool based on runtime conditions, (iv) overlay, in part, a functionality of the second process or tool with that of a third process or tool in order to optimize or alter interactions between a software application and the second process or tools.

11-13. (canceled)

14. The method of claim 1, wherein the first process or tool, by its ability to at least one of track, collect, or analyze IPC calls, is configured to interact with at least one of:
a computer node operating system to change at least one of a priority, a process placement policy, an NUMA memory allocation or a migration of a running application process,
the second process or tool to set runtime parameters as a buffer allocation, a threshold between IPC component selection, or a channel selection,
a compute node resource including at least one of a processor, controllers, or accelerators to improve performance or stability,
a compute node processor to optimize at least one of a cache memory allocation or a bandwidth based on recorded information,
a network controller to provide the network controller with information on at least one of a current network traffic or an expected network traffic to optimize the runtime parameters as message routing or message priority, or
a communication pattern optimization mechanism that, based on at least one of a recent message tracking or a message analysis, at least one of reorders messages, aggregates messages, or substitutes application programming interface (“API”) calls.

15. The method of claim 14, wherein the communication pattern optimization mechanism is based on a software module running within the first process or tool, an artificial intelligence (“AI”) module running on a GPU, or any other software-based mechanism or hardware-based mechanism that given a set of parametrized data provides an optimized schedule of operation.

16. The method of claim 1, further comprising aggregating messages from the first process or tool and the second process or tool when the messages have a common route.

17. The method of claim 1, wherein after completion or use of the first process or tool by a software application, the first process or tool is available for use by another software application.

18. The method of claim 17, wherein the first process or tool is configured to be used concurrently by multiple applications.

19. The method of claim 1, further comprising initializing at least one of the first process or tool or the first process or tool.

20. The method of claim 1, further comprising identifying the at least one first IPC translation context based on a destination IPC context, wherein the at least one first IPC translation context is based on at least one of a process identifier, a node identifier, a node configuration, a network identifier, a network topology, user supplied preferences, or performance statistics.

21. The method of claim 1, wherein:
the at least one call is a point-to-point application programming interface (“API”) call when the first process or tool is not directly connected to the second process or tool, and
the point-to-point API call between the two processes is achieved through a series of forwarding point-to-point calls between intermediate processes.

22. The method of claim 21, wherein the at least one call is a collective API call when the first process or tool uses a combination of second processes or tools performing forwarding collective or the point-to-point API calls to reach all software application processes involved in the collective call.

23. The method of claim 21, wherein the at least one call is a collective API call when the first process or tool is using a sequence of second processes or tools to optimize performance.

24. The method of claim 23, wherein the second process or tool is optimized for intra-node collective function, and thereafter, the second process or tool optimized for inter-node collective function.

25. The method of claim 1, further comprising performing an asynchronous communication operation by substituting blocking wait calls with non-blocking test calls.

26. A system for facilitating inter-process communication (“IPC”) of a plurality of IPC processes or tools, comprising:
a computer hardware arrangement configured to:
using an IPC platform, intercept at least one call from a first process or tool of the IPC processes or tools intended to be provided to a second process or tool of the IPC processes,
identify at least one first IPC translation context of the IPC processes based on the first process or tool, and
translate the at least one first IPC translation context to at least one second IPC translation context usable by the second process or tool.

27-50. (canceled)

51. A non-transitory computer-accessible medium having stored thereon computer-executable instructions for facilitating inter-process communication (“IPC”) of a plurality of IPC processes, wherein, when a computing arrangement executes the instructions, the computing arrangement is configured to perform procedures comprising:
using an IPC platform, intercepting at least one call from a first process or tool of the IPC processes intended to be provided to a second process or tool of the IPC processes;
identifying at least one first IPC translation context of the IPC processes based on the first process or tool; and
translating the at least one first IPC translation context to at least one second IPC translation context usable by the second process or tool.

52-75. (canceled)
